(19) United States
(12) Patent Application Publication
(10) Pub. No.: US 2006/0107516 A1
(43) Pub. Date: May 25, 2006

(54) Intermittently connected metal matrix composite bars

(75) Inventors: Brian E. Joseph, Wheeling, WV (US); Robert Nolte, Wheeling, WV (US); Matthew M. Rowe, Wheeling, WV (US); James F. Witzgall, Wheeling, WV (US); Gregg W. Wolfe, Wheeling, WV (US)

Correspondence Address: PHILIP D. LANE, P.O. BOX 79318, CHARLOTTE, NC, 28271-7063, US

(73) Assignee: Touchstone Research Laboratory, Ltd.

(21) Appl. No.: 11/051,488

(22) Filed: Feb. 4, 2005

Related U.S. Application Data
(63) Continuation of application No. 10/995,517, filed on Nov. 24, 2004.

(51) Int. Cl. B23P 13/04

(52) U.S. Cl. 29/557

(57) ABSTRACT

The present invention provides for assemblies comprising metal matrix composite bars where the bars only intermittently have mutual contact. Minimally two bars of metal matrix composite are joined, for example by lap joints, or by the use of incorporated tabs and slots or over-lapping slots, at areas of mutual contact to form the assemblies. The metal matrix composite assemblies of the present invention may be readily assembled to provide structures, supports, or sub-assemblies, and the like, that may exhibit high strength and stiffness coupled with relatively low mass. Additionally, such assemblies may withstand exposure to elevated temperatures higher than can be tolerated by polymeric composites. Such assemblies are expected to be particularly suitable for lightweight, stiff support structures for space booms, satellite structures, mirror backings, solar panel supports, wall reinforcement, and the like.

CROSS-REFERENCE TO RELATED APPLICATIONS

The present application claims priority to U.S. Provisional Patent Application No. 60/525.837, filed Dec. 1, 2003 and U.S. Provisional Patent Application No. 60/526,100, filed Dec. 2, 2003, each of which are specifically herein incorporated by reference in their entirety.

This invention was made with Government support under contract number DAAD19-01-2-0006 awarded by the Army Research Laboratory. The Government has certain rights in the invention.

FIELD OF THE INVENTION

The present invention relates to assemblies comprising metal matrix composites. More particularly, this invention relates to assemblies comprising metal matrix composite bars, wherein said bars intermittently contact themselves or other metal matrix composite bars.

### BACKGROUND OF THE INVENTION

Generally, composite materials are prepared by imbedding a reinforcing material within a matrix material. A common example of a composite material is fiberglass. Fiberglass is glass fibers, which are the reinforcing material, embedded in a cured resin, which constitutes the matrix material.

One class of composites is metallic matrix composites. Metallic matrix composites, also referred to as metal matrix composites, utilize metal as the matrix material. Suitable metals for use as the matrix may be alloys or pure metals. Metallic composites may utilize fibrous or particulate reinforcements. Fibrous reinforcements can be continuous or discontinuous with random or specific orientations. Such fibers may comprise, for example, aluminum oxide, silicon carbide, or carbon. Particulate reinforcements may comprise, for example, metals, ceramics, carbides, or intermetallic compounds.

The utility of any composite is typically related to its high strength or stiffness to weight, or volume, ratio and, sometimes, to its fatigue resistance. Such beneficial properties of composites are typically a result of load sharing between the matrix materials and reinforcing materials. In many instances, these beneficial properties exceed those of the materials supplanted by the use of the composites.

As a result of their beneficial properties, metallic composites have potential utility in numerous applications. But, to date, metallic composites have been widely used in only a limited number of applications. The integration of metallic composites into existing or proposed structural designs has typically required the preparation of metallic composites having essentially custom configurations. This requirement for such custom configurations further increases production costs, typically to the point that the use of metallic composites can not be economically justified for most applications.

Metal matrix composite bars, specifically tapes, have been previously assembled to produce both flat and cylindrical structures. For example U.S. Pat. No. 5,968,671 discloses a compound composite assembly comprised of aluminum matrix strands reinforced by having tow based aluminum oxide fibers extending the length of the strands to form flat structures. This assembly comprises layers of these strands. In each layer, the strands are mutually parallel to, and essentially touching, each other. The layers are stacked one upon another, with the long axis of the strands in each layer being off-set by some amount to that of neighboring layers by as much as 90 degrees. The individual strands and layers are brazed together to form the compound composite assembly of the invention. In this assembly, aluminum metal matrix strips are in essentially continuous contact with, and bonded to, neighboring strips.

In another example, U.S. Pat. No. 6,455,804 discloses a method for the fabrication of large metal matrix composite assemblies in the form of cylindrical structures. Such assemblies are aluminum matrix braze-clad tape that is applied in layers to a rotating mandrel. As the tape is applied to the mandrel it is brazed to previously applied layers of tape. The result of this application is the formation of an essentially solid wall cylinder from aluminum matrix composite tape. The tape forming the cylinder of this invention is in essentially continuous contact with, and bonded to, previously and subsequently applied layers of the same tape.

These flat and cylindrical assemblies potentially have great utility in a variety of applications, but other potential metal matrix composite applications may require more complicated shapes or structures. Therefore it would be advantageous to provide metal matrix composites in other shapes and structures that can be readily integrated into existing or proposed structural designs.

### DESCRIPTION OF THE FIGURES

FIG. 1 illustrates two joist-like assemblies (A) and (B) comprising lap joined metal matrix composite bars in accordance with an embodiment of the invention.

FIG. 2 illustrates a formed piece of metal bonded to a metal matrix composite tube to provide a tab in accordance with an embodiment of the invention.

FIG. 3 illustrates (A) a metal matrix composite tape with a tab and slot, (B) a metal matrix composite tape with tabs, and (C) an assembly resulting from the joining of metal matrix composite tapes in accordance with an embodiment of the invention.

FIG. 4 illustrates (A) a metal matrix composite tape with slots, and two assemblies (B) and (C) resulting from the joining of metal matrix composite tapes by the use of over-lapping slots to form an assembly in accordance with certain embodiments of the invention.

FIG. 5(A)-(D) illustrate reinforcements of the intermittently connected joints in accordance with embodiments of the invention.

### SUMMARY OF THE INVENTION

The present invention provides for the metal matrix composite assemblies and methods for preparing such assemblies. Such assemblies may provide a structure, a subassembly of a structure or another assembly, or be used to support other assemblies, materials, or structures. These metal matrix composite assemblies comprise at least in part metal matrix composite bars. In the present invention, the metal matrix composite bars only intermittently contact themselves or other metal matrix composite bars. The metal matrix composite bars are joined, i.e. connected, at the intermittent areas of mutual contact. The assemblies of the present invention are prepared by connecting the metal matrix composite bars at the areas of mutual contact. The bars may be bent as required to provide the desired form of an assembly. The design of the assembly should be such that the weight and/or strength advantages provided by the metal matrix composite are utilized. Such assemblies may encompass cross-bracing, triangular components, and the like, to advantage. Other materials may be utilized in the assemblies of the present invention to further accentuate the beneficial properties of the metal matrix composites.

The metal matrix composites used in the present invention are preferably continuous fiber reinforced metal bars, including tapes, tubes, angles, channels, and the like. The matrix metal used in these composites may be any metal, including pure metals and alloys of metals. Preferably, the matrix metal is a light weight metal and may comprise, but is not limited to, aluminum, aluminum alloys, magnesium, magnesium alloys, and the like. The continuous fiber reinforcement of such metal matrix composites may be, but is not limited to, aluminum oxide, basalt, glass, quartz, boron, silicon carbide, carbon fibers, and the like. Such continuous fiber reinforcement can be oriented parallel to the length of the metal matrix composite bar.

The use of the continuous fiber reinforced metal bars of the present invention is particularly advantageous as such metal matrix composites can exhibit tensile strengths, compressive strengths, and/or moduli of elasticity typically greater than conventional materials of similar size or weight. Such beneficial mechanical and/or physical properties may impact on the properties of the assemblies of the present invention to provide for structures, sub-assemblies, supports, and the like, having mechanical and/or physical properties which can be superior to those of similar assemblies comprising conventional materials.

In the present invention, minimally two bars of metal matrix composite are intermittently joined at the area of mutual contact, for example, by lap joints, by incorporated tabs and slots, or over-lapping slots, to form the assemblies. Other joining methods may be utilized.

The metal matrix composite assemblies of the present invention may be readily assembled and can provide assemblies, structures, supports, or sub-assemblies, and the like, that can exhibit high strength and stiffness coupled with relatively low mass. Additionally, such assemblies may withstand exposure to elevated temperatures higher than can be tolerated by polymeric composites. The assemblies of the present invention may replace or otherwise supplant assemblies, sub-assemblies, structures, and the like that would otherwise be constructed entirely of alternative materials.

Such assemblies are expected to be particularly suitable for lightweight, stiff support structures for space booms, satellite structures, mirror backings, solar panel supports, wall reinforcement, and the like.

### DETAILED DESCRIPTION OF THE INVENTION

The present invention provides for assemblies comprising metal matrix composite bars. The assemblies of the present invention may provide a structure, a subassembly of a structure, a part of another assembly, or be used to support other assemblies, materials, or structures. Minimally, the assemblies of the present invention comprise two metal matrix composite bars. More often, these assemblies comprise more than two metal matrix composite bars. The assemblies of the present invention may also comprise materials other than metal matrix composite bars.

The assemblies of the present invention differ from those of the prior art in that the metal matrix composite bars utilized in the present invention only intermittently contact themselves or other metal matrix composite bars. Each metal matrix composite bar of the present invention intermittently contacts, and is joined to at that area of contact, to at least one other metal matrix composite bar. Connection, or joining, at the area of contact may be temporary or permanent and may utilize lap joints, incorporated tabs and slots, over-lapping slots, and the like to affix one bar to another. The joining of the metal matrix composite bars may result in a linear arrangement of the bars. Alternatively, the joining may result in the bars being at any angle relative to each other. Furthermore, the connecting areas may be reinforced or otherwise strengthened by the application of bracing components, mechanical restraints, and/or clamps to the joining area.

The metal matrix composite bars may comprise any metal matrix composite that provides for bars having properties compatible with the mechanical and environmental requirements of the application in which the assembly of the present invention will be utilized. Suitable metal matrix composites may utilize continuous fibers, discontinuous fibers, or particulates as the reinforcing material and a metal or metal alloy as the matrix material. Typically, useful reinforcing materials are those that exhibit mechanical properties superior to the matrix metal and are not significantly degraded by any processing conditions required to form the composite or by contact with the matrix metal during or after such processing.

The metal matrix composite bars used in the present invention are preferably continuous fiber reinforced metal matrix composites. The matrix metal of these metal matrix composites is preferably a light weight metal and may comprise, but is not limited to, aluminum, aluminum alloys, magnesium, magnesium alloys, and the like. The continuous fiber reinforcement of such metal matrix composites may comprise, but is not limited to, aluminum oxide fibers, basalt fibers, glass fibers, quartz fibers, boron fibers, silicon carbide fibers, carbon fibers, and the like. Such continuous fiber reinforcement is typically oriented parallel to the length of the metal matrix composite bar. Other continuous fiber orientations can be utilized. For example, the fiber orientation can be transverse, or any orientation between parallel and transverse, to the length of the metal matrix composite bar. For example, the fiber arrangement of a metal matrix composite tube may be hoop or helical.

The use of the continuous fiber reinforced metal matrix composite bars in the present invention is advantageous as such metal matrix composites can exhibit tensile strengths, compressive strengths, and moduli of elasticity typically greater than conventional materials of similar size or weight. Such beneficial mechanical properties may impact on the properties of the assemblies of the present invention to provide for structures, supports, sub-assemblies, and the like having mechanical properties superior to those structures, supports, or other assemblies prepared from conventional, typically monolithic, materials. Additionally, metal matrix composites can tolerate higher temperatures than polymers and polymeric composite materials. As such, the use of metal matrix composites can provide for light weight assemblies compatible with higher temperature environments.

The metal matrix composite bars utilized in the present invention may have circular, square, rectangular, triangular, polygonal, ellipsoid, “I”, “L”, “U”, or other cross sectional shapes. The lengths and cross-sectional dimensions of these bars are selected based on the design requirements and characteristics of the assembly. Some of these metal matrix composite bars may be commonly referred to as tapes, square tubes, round tubes, rods (including wires), round bars, channels, angles, or the like. Metal matrix composite tape may be produced in a number of sizes and is available commercially in widths of 0.25 to 1.25 inches and thicknesses of about 0.008 inches to about 0.030 inches (METPREG™, Touchstone Research Laboratory, Ltd.). Metal matrix composite tubes, angles, channels, and the like may have wall thicknesses in a range similar to that of metal matrix composite tape. Typically, the outer diameters, leg lengths, and the like of metal matrix composite tubes, angles, and channels and the like reflect those of similar conventional metal bars having comparable wall thicknesses.

More than one type of metal matrix composite bar may be used in a given assembly. That is, a given assembly may comprise metal matrix composite bars having different cross-sectional shapes and/or dimensions. For example, a three dimensional rectangular assembly having edges comprised of metal matrix composite tubes may utilize metal matrix composite tape as angular bracing between opposite intersections of such tubes. Additionally, metal matrix composite bars having different compositions may be used in a given assembly. For example, a metal matrix composite bar comprising an aluminum matrix and an aluminum oxide fiber reinforcement, a metal matrix composite bar comprising a magnesium matrix with a carbon fiber reinforcement, and a composite bar comprising a zinc matrix with a silicon carbide particulate reinforcement may all be utilized in the same assembly. The ability to combine different types of metal matrix composite bars in a single assembly is advantageous as assembly designs can be optmized for the intended application with respect to strength, mass, stiffness, and/or cost.

Also, other materials may be utilized in the present invention to reduce the metallic matrix composite bar content of an assembly for economic or other reasons. Such other materials can provide for support of the assembly or component parts of the assembly. These other materials may be of any geometric configuration. Typically, such materials are utilized in less demanding load bearing support functions. Such other materials may be, but are not limited to, metals, ceramics, plastics, polymeric composites, wood, and the like. Additionally, the assemblies of the present invention may also incorporate other types of metal matrix composites, including those comprising metal matrix composite bars in continuous contact with each other, in addition to those metal matrix composite bars in intermittent contact with each other. It is generally desirous that any assembly utilizing other materials be so designed that the resistance to any significant applied force is provided by the metal matrix composite portion of that assembly.

The assemblies of the present invention are prepared by connecting metal matrix composite bars, at areas of mutual contact, to form the desired assembly. Typically, the length of these bars is greater than the maximum cross-sectional dimension of the metal matrix composite bar. The design of the assembly preferably should be such that the weight and/or strength advantages provided by use of metal matrix composites are utilized.

For example, continuous fiber reinforced metal matrix composites are typically anisotropic materials with respect to strength and/or stiffness. Those continuous fiber reinforced bars having such fibers oriented along the length of the bar typically exhibit significant strength in tension or compression (along the length of the bar). Therefore, assemblies are preferably designed such that the metal matrix composite bars comprising the assembly are put into tension or compression by any significant applied force. Such assemblies may encompass cross-bracing, triangular component arrangement, and the like, to provide for the desired resistance to forces applied to the assembly. Examples of such assemblies may include, but are not limited to, isogrids, I-beams, trusses, or other types of structural elements. Other assemblies can include those structures that are combinations of these structural elements. Still other assemblies can incorporate novel designs to provide the structures, structure subassemblies, supports, or the like, based on the teachings of the present invention.

Some assembly designs require the use of bent metal matrix composite bar. Depending on the type and shape of the metal matrix composite, a metal matrix composite bar utilized to form a desired assembly may be bent to provide a desired configuration. Heating of the metal matrix composite, even to temperatures above which the matrix metal is initially softened, may be used to facilitate bending. Bending of bars can provide for two or more areas of intermittent contact between two different bars.

The metal matrix composite bars are preferentially joined (i.e. connected) to form the assemblies of the present invention using lap joints, incorporated tab and slot connections, or over-lapping slot connections. Other joining methods may be used. Lap joints may be established by overlapping areas of minimally two metal matrix composite bars and joining the bars the area of contact provided by the over-lap. The lap joint may be secured by the use of adhesive bonding, welding (including ultrasonic welding), brazing, soldering, and the like to provide a rigid connection. The overlapping surfaces of the metal matrix composite bars may be coated or layered with materials to facilitate joining by the use of brazing, welding, soldering, and the like. These coating materials can include, but are not limited to fluxes, solders, brazing metals, and other metals. Such techniques may also be applied to join non-overlapping ends of two or more metal matrix composite bars to each other.

Alternatively or additionally, lap joints may be secured by mechanical fasteners such as screws, rivets, or the like, typically after the forming of an appropriately sized hole through the over-lapping bars. Such holes may be formed by formed by conventional methods. Alternatively, such holes may be formed by heating the metal matrix composite such that the matrix metal is softened and then while still softened, punching a hole through the metal matrix composite with a pointed tool. This later method can be advantageous as fiber reinforcements, if present, may be pushed aside, rather than cut, during hole formation. As a result, this method may result in less composite strength loss due to hole formation as compared to conventional methods of hole formation. Also, clamping devices may be used to secure lap joints. For all lap joints, additional bracing of various designs can be used to provide reinforcement to the joint.

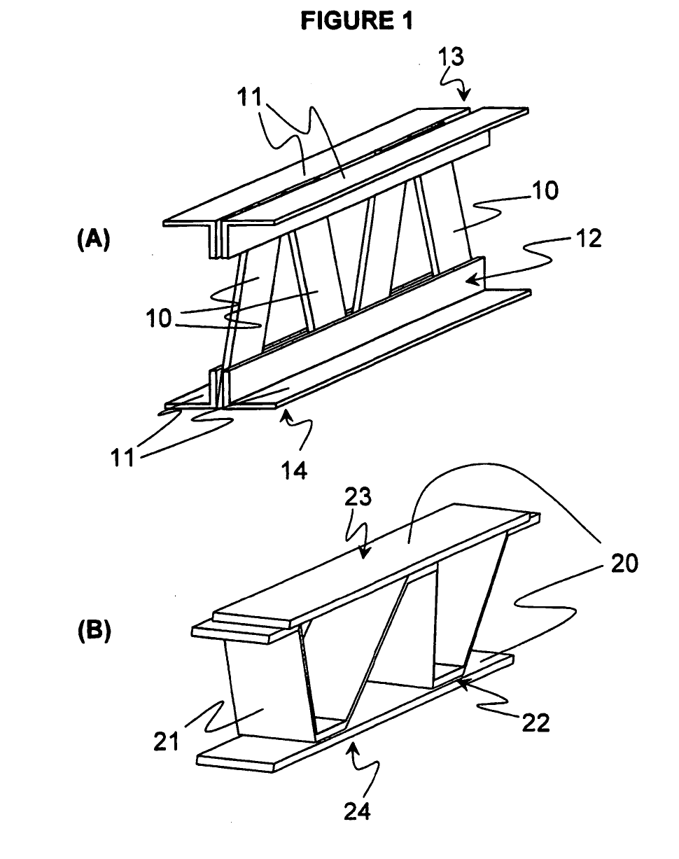

Two assemblies comprising lap joined metal matrix composite bars are illustrated in FIG. 1. FIG. 1 (A) provides a representation of a joist-like assembly comprising relatively short bars of metal matrix composite tape (10) and bars of metal matrix composite angles (11). Areas of overlap of these components (12, for example) are joined by the use of an adhesive. Such assemblies may be utilized much as are conventional trusses and are particularly resistant to loads applied perpendicular to the upper (13) and lower (14) surfaces of the assembly. FIG. 1 (B) provides a representation of another joist-like assembly. This assembly comprises two straight bars of metal matrix composite tape (20) and a bent bar of metal matrix composite tape (21). Areas of overlap of these components (22, for example) are joined by the use of brazing. Assemblies similar to that of FIG. 1 (B) could also be prepared by substituting straight bars of metal matrix composite angle, channel, tubing, or the like, for the straight bars of metal matrix composite tape (20). Such assemblies may be utilized much as are conventional trusses and are particularly resistant to loads applied perpendicular to the upper (23) and lower surfaces (24) of the assembly.

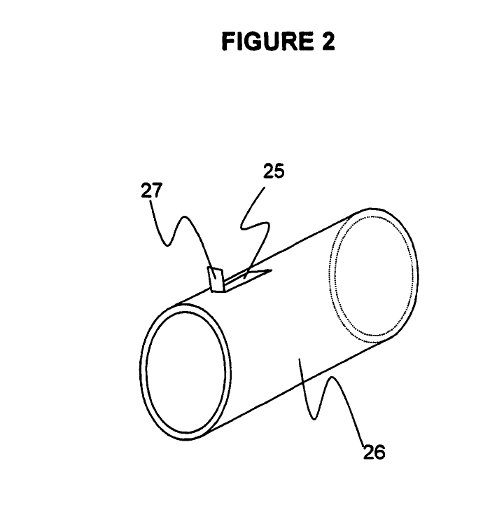

Joining of the metal matrix composite bars may also be accomplished by the use of tab and slot connections. Tabs and slots are specially shaped areas of the metal matrix composite bars. Such specially shaped areas may be produced by any of a number of different methods, including, for example, stamping or machining. Alternatively, a metal, a metallic composite, or other type of material may be fabricated such that it can be bonded or otherwise attached to a metal matrix composite bar to provide a tab. An example of such an arrangement is illustrated in FIG. 2. As shown in this Figure, a portion (25) of a formed piece of metal is bonded to a metal matrix composite bar which is, in this illustration, a tube (26). Another portion (27) of the formed piece of metal, not bonded to the tube, is shaped such that it forms a tab that may be utilized for subsequent attachment to a slot of a second (not illustrated) metal composite bar. Alternatively, the formed piece of metal could be connected to the illustrated tube by use of a tab. Typically, slots and tabs are designed such that the tab of one metal matrix composite bar fits securely into the slot of another metal matrix composite bar. The tab may be secured within the slot by, for example, friction, an interference fit, bending the tab, or bonding the tab to the slot containing bar. Such bonding may be accomplished by the use of adhesive bonding, welding (including ultrasonic welding), brazing, soldering and the like. Mechanical fasteners or restraints of various designs may also be used to secure the tabs within the slots. Bracing components of various designs may also be used to secure or support the tab/slot jointure.

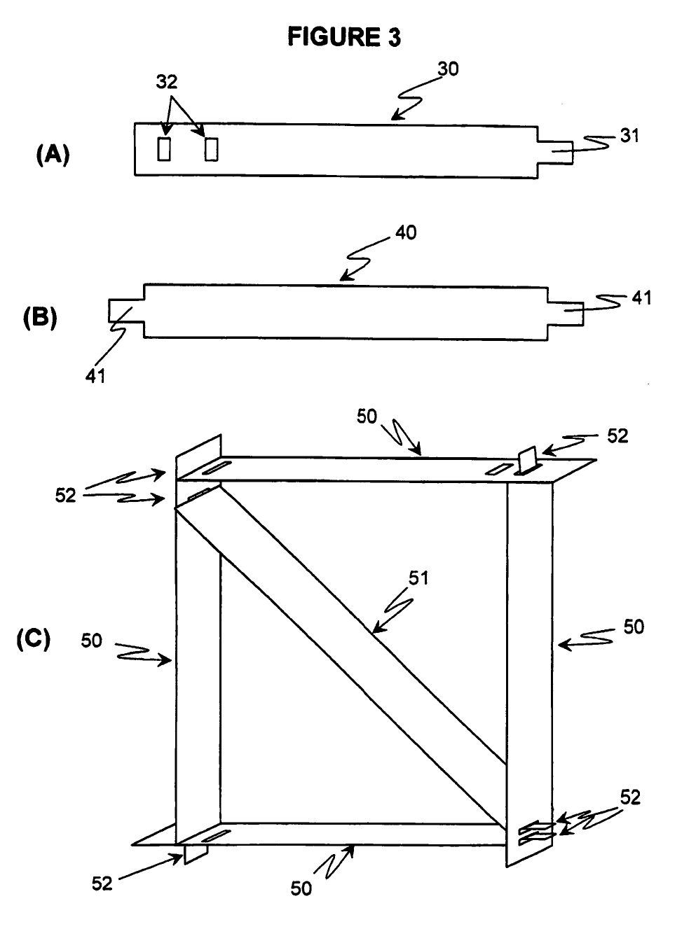

A representation of one type of tab and slot connection to provide an assembly of the present invention is illustrated in FIG. 3. FIG. 3 (A) provides a representation of a bar of a metal matrix composite tape (30) of a first configuration, one end of which is shaped to form a tab (31). Located near the end of the tape opposite that end having the tab (31) are two slots (32). FIG. 3 (B) provides a representation of a metal matrix composite tape (40) of a second configuration, both ends of which are shaped to form tabs (41). FIG. 3 (C) provides an illustration of an assembly formed from four bars of metal matrix composite tape of the first configuration and one bar of metal matrix composite tape of the second configuration. For this assembly, the tape bars of the first configuration (50) form the outer portion of the assembly while a tape bar of the second configuration (51) provides a type of cross-bracing, that is, reinforcement, to the assembly. The tabs and slots of each bar are mated with corresponding slots and tabs on other bars (52) to orientate the tapes and provide the resultant triangularly braced assembly. Tabs may be secured within slots by bending, friction-fitting, an interference fit, mechanical fasteners, or the use of adhesive bonding, brazing, welding (including ultrasonic welding), soldering, and the like. Metal matrix composites tape assemblies of the type shown in FIG. 3 (C) can be very rigid and exhibit excellent strength to weight ratios. Such assemblies may be of any size. Additionally, the methods exemplified by this representation may be used to prepare assemblies of various designs for use as structures, supports, and the like.

Although FIG. 3 illustrates only the use of metal matrix composite tapes, such tab and slot joining can also be applied to other types of metal matrix composite bars, including tubes, channels, angles, and the like, either alone or in combination with other types of metal matrix composite bars. Also, tabs and slots do not have to be positioned on or near the ends of the composite bars used in a given assembly. Slots may be located on/in any surface of a bar sufficiently large as to define the slot. Tabs may be located on any portion of a bar of sufficient size as to provide for fabrication of the tab. Although not generally preferred, tabs may also be provided by attaching individual sections of material to a metal matrix composite bar.

The methods illustrated in FIG. 3 can be expanded to prepare other, potentially more complicated, assemblies. For example, metal matrix composite bars can be utilized having numbers and locations of tabs and slots different that those shown for the strips depicted in this Figure. By such means, larger, more complex, or geometrically different assemblies may be prepared. Such different assemblies may encompass but are not limited to, repeating structural units, curved geometries, and other known geometric shapes.

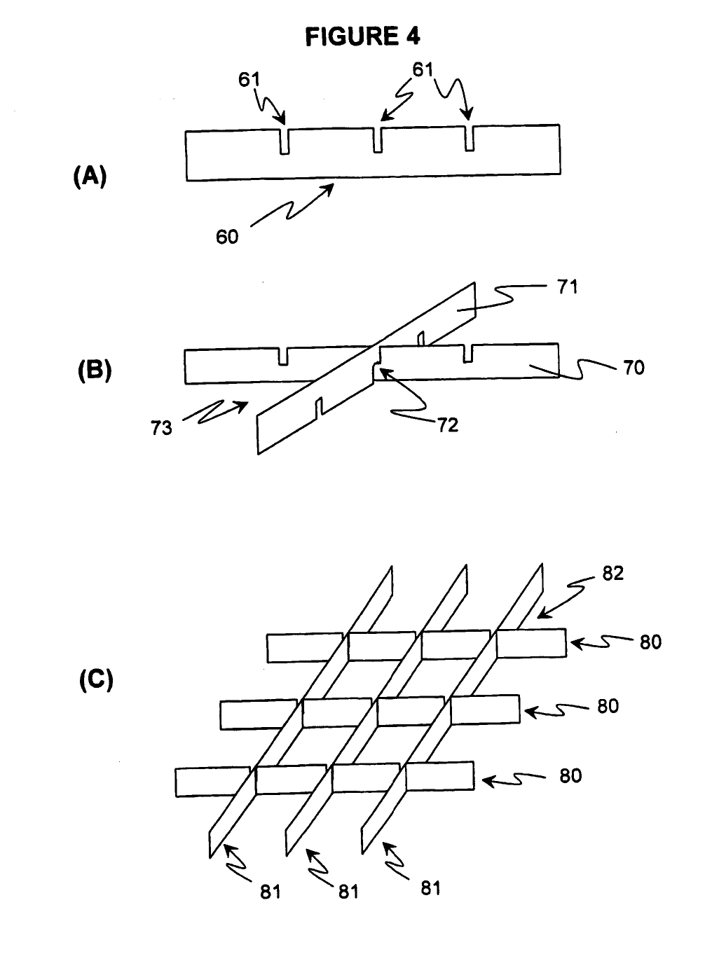

Another method for the joining of metal matrix composite bars to provide assemblies is the use of over-lapping slot connections. For example, FIG. 4 provides a representation of the joining of metal matrix composite tapes by the use of over-lapping slot connections to form an assembly. FIG. 4 (A) shows a metal matrix composite bar, specifically a tape (60), into which slots (61) have been formed. FIG. 4 (B) illustrates two tape bars, both essentially equivalent to that bar shown in FIG. 4 (A). In FIG. 4 (B) one tape bar is shown with the slots facing upward (70) and the other bar is shown with the slots facing downward (71). The two bars are so arranged that the middle slots of each are combined (72) such that the two bars form an assembly (73). In this manner, additional bars of slotted metal matrix composite tape, some with the slots facing upward (80), and some with the slots facing downward (81) may be combined as shown in FIG. 4 (C) to provide an assembly (82). The metal matrix composite tapes comprising this assembly may be held in place by slots having size tolerances such that a strong “friction” fit is obtained. The bars of tape may also be held in place by the use of adhesive bonding, brazing, welding, soldering, and the like, applied to the overlapping tape junctures. Mechanical fasteners, restraints, and bracing components of various designs may also be used to secure the tapes in the desired configuration. The use of slots, as illustrated for the joining of metal matrix composite tape lengths. may also be applied to other types of metal matrix composite bars, including tubes, channels, angles, and the like, either alone or in combination with other types of metal matrix composite bars. Assemblies such as that represented in FIG. 4 (C) are particularly suitable for use as reinforcement to other structures and assemblies.

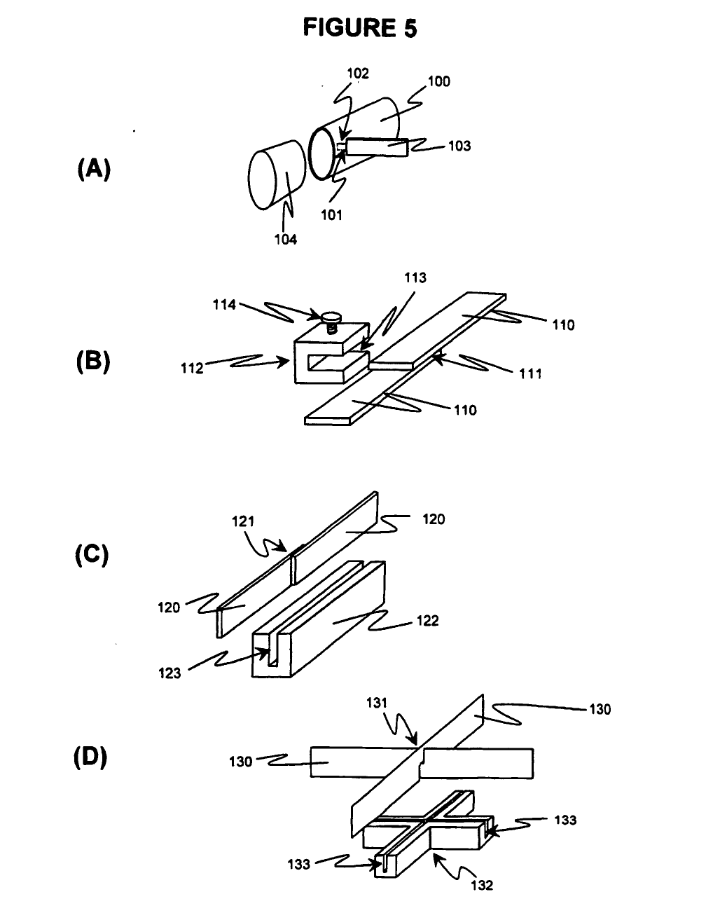

As has been previously mentioned, clamps, mechanical restraints, and bracing components of various designs may be utilized to strengthen or other wise reinforce the joining methods of the present invention. These clamps, mechanical restraints, and bracing components may comprise any solid material having mechanical properties suitable for the application. A few different types of these strengthening/reinforcing components, and associated method of use, are illustrated in FIG. 5. FIG. 5(A) illustrates a metal matrix composite tube (100) having a slot (101) into which the tab (1 02) of a bar of metal matrix composite tape (1 03) is inserted. Also shown is a tapered plug (104) sized fit into the tube end. The tab may be secured within the tube by driving the tapered plug into the tube end such that it firmly compresses the tab against the tube wall. As desired, the tab may also be bonded or welded in the slot by any of the previously disclosed methods.

FIG. 5(B) illustrates two bars of metal matrix composite tape (110) connected using a lap joint (111). Also illustrated is a clamping device (112) having a throat (113), sized such that it can encompass the lap joint, and a screw (114) that can be tightened to decrease the throat height. Insertion of the lap joint into the clamping device throat followed by tightening of the clamping device screw serves to compress, and thus reinforce, the lap joint.

FIG. 5(C) illustrates two bars of metal matrix composite tape (120) connected using a lap joint (121). Also illustrated is a bracing component (122) having a slot (123) sized such that it can encompass the lap joint and some portion of the composite tape on either side of the lap joint. Once inserted into the slot, the tapes and lap joint may be secured, for example, within the bracing component by any of the previously disclosed bonding methods to reinforce the lap joint. Alternatively, if the bracing component is constructed of a malleable material such as a metal, the component may be compressed to collapse the slot and thus retain the tapes and lap joint.

FIG. 5(D) illustrates two bars of metal matrix composite tape (130) connected using over-lapping slots (131). Also illustrated is a bracing component (132) having slots (133) sized such that the slots can encompass some portions of the composite tapes at and around the area of the over-lapping slots. Once inserted into the slot, the tapes and jointure may be secured, for example, within the bracing component by any of the previously disclosed bonding methods to reinforce the over-lapping slots. Alternatively, if the bracing component comprises a malleable material such as a metal, the component may be compressed to collapse the slots and thus retain the tapes and jointure.

Additionally, a kit may be provided to enable relatively rapid production of custom assemblies according to embodiments of the invention. Such a kit may include an assortment of metal matrix composite bars, including, but not limited to, tapes, tubes, or angles may be provided from which the assemblies of the present invention may be readily prepared. The metal matrix composite bars of the assortment may be modified by the incorporation of slots and taps, or opposing slots. Alternatively, tools for the formation of slots and taps and/or over-lapping slots may be included with the assortment of metal matrix composite bars. Additionally, components to practice any of the disclosed joining methods may also be included with the assortment of metal matrix composite bars. For example, an embodiment of a kit may include a plurality of metal matrix composite bars having slots and/or tabs in various positions similar to those illustrated in FIG. 3(A) and 3(B) that can be used to form a wide array of assemblies. Another example may include a plurality of slotted metal matrix composite bars, such as the tapes similar to those illustrated in FIG. 4(A), of various sizes that can be used to form various structures and assemblies. Further, the kit may include joining agents or tools. The joining agents may include, adhesives, solder, adhesive tape, clamps, bracing components and other similar agents. The joining tools may include devices for welding, soldering, brazing, or the like.

The metal matrix composite assemblies of the present invention may be readily assembled to provide structures, supports, or sub-assemblies that may exhibit high strength and stiffness coupled with relatively low mass. Such assemblies are therefore expected to be useful for the support, strengthening, and/or stiffening of other structures or materials. Additionally, such assemblies may withstand exposure to elevated temperatures higher than can be tolerated by polymeric composites. Therefore structures comprising assemblies of the present invention may replace or otherwise supplant structures that would otherwise comprise alternative materials. As the assemblies of the present invention comprise a metal matrix composite, such that the afore mentioned beneficial properties are present, they are particularly suitable for lightweight, stiff support structures for space booms, satellite structures, mirror backings, solar panel supports, wall reinforcement, and the like.

The above examples are not to be considered limiting and are only illustrative of a few of the many embodiments of the invention. The present invention may be varied in many ways without departing form the scope of the invention and is only limited by the following claims.

1.-27. (canceled)

28. A method for bending a metal matrix composite, comprising the steps of:
heating a metal matrix composite to temperature above which the metal matrix composite is initially softened; and
bending the metal matrix composite into a desired configuration.

29. The method of claim 28, wherein said metal matrix composite comprises a plurality of continuous alumina fibers in a matrix comprising aluminum.

30. A method for forming a hole in a metal matrix composite, comprising the steps of:
heating a metal matrix composite comprising a plurality of continuous fibers in a matrix metal such that the matrix metal is softened; and
producing a hole through the metal matrix composite while the matrix metal is softened.

31. The method of claim 30, wherein the step of punching a hole further comprises using a pointed tool to form the hole in the metal matrix composite.

32. The method of claim 31, wherein the step of punching a hole further comprises pushing aside the continuous fibers during formation of the hole.

33. The method of claim 31, wherein said metal matrix composite comprises a plurality of continuous alumina fibers in a matrix comprising aluminum.
